(19) United States
(12) Patent Application Publication
(10) Pub. No.: US 2025/0033716 A1
(43) Pub. Date: Jan. 30, 2025

(54) SUPPORT FRAME FOR SPARE WHEEL

(71) Applicant: Ford Global Technologies, LLC, Dearborn, MI (US)

(72) Inventors: Mohammad Omar Faruque, Ann Arbor, MI (US); S.M. Iskander Farooq, Novi, MI (US); Dean M. Jaradi, Macomb, MI (US)

(73) Assignee: Ford Global Technologies, LLC, Dearborn, MI (US)

(21) Appl. No.: 18/360,991

(22) Filed: Jul. 28, 2023

(51) Int. Cl. B62D 43/04

(52) U.S. Cl. CPC B62D 43/04

(57) ABSTRACT

A vehicle includes an underbody and a support frame supported by the underbody. The support frame is configured to support a spare wheel. The support frame includes a first end pivotally connected to the underbody and a second end releasably connected to the underbody. A tether extends from the support frame to the underbody. The tether is fixed to the support frame and the underbody. A stud is between the support frame and the underbody. The stud is releasably connected to the underbody.

### BACKGROUND

A spare wheel is a tire carried on board a vehicle to use as a replacement for one of the operating wheels in case the operating wheel is flat or otherwise needs replacing. A spare wheel typically includes a tire and a wheel to facilitate replacement. Some spare wheels are the same type as the operating wheels, and some spare wheels are smaller than the operating wheels, sometimes called compact spares.

### BRIEF DESCRIPTION OF THE DRAWINGS

FIG. 1 is a perspective view of an underside of a vehicle.

FIG. 2 is a perspective view of a support frame for a spare wheel in a stowed position.

FIG. 3 is a perspective view of the support frame for the spare wheel in a pivoted position.

FIG. 4A is a perspective view of a first example of a stud and an actuator for the support frame that are unreleased.

FIG. 4B is a perspective view of the first example of the stud and the actuator for the support frame that is released.

FIG. 5A is a perspective view of a second example of the stud and the actuator for the support frame that is unreleased.

FIG. 5B is a perspective view of a second example of the stud and the actuator for the support frame that is released.

FIG. 6 is a vehicle communication network of the vehicle.

FIG. 7 is a flowchart of a method executable by a vehicle computer on the vehicle communication network.

### DETAILED DESCRIPTION

A vehicle includes an underbody and a support frame supported by the underbody. The support frame is configured to support a spare wheel. The support frame includes a first end pivotally connected to the underbody and a second end releasably connected to the underbody. A tether extends from the support frame to the underbody. The tether is fixed to the support frame and the underbody. A stud is between the support frame and the underbody. The stud is releasably connected to the underbody.

The vehicle may include an actuator operatively connecting the stud to the underbody to release the stud from the underbody.

The stud may include a first portion and a second portion. The first portion may be between the underbody and the second portion. The actuator may be between the first portion and the second portion.

The actuator may include a solenoid between the first portion of the stud and the second portion of the stud. The solenoid may include a housing and a plunger.

The stud may be elongated along a first axis and the plunger of the solenoid is elongated along a second axis transverse to the first axis. The plunger may be releasably engaged with the first portion and the second portion along the second axis.

The stud may be elongated along a first axis, the actuator may be between the first portion of the stud and the second portion of the stud along the first axis and the actuator may be pyrotechnically activated.

The actuator may be pyrotechnically activated.

The vehicle may include a computer including a processor and a memory storing instructions executable by the processor to detect certain vehicle impacts and, based on detection of certain vehicle impacts, activate an actuator to release the stud from the underbody.

The stud may extend from the support frame to the underbody.

The vehicle may include a spring between the stud and the underbody. The spring may bias the stud away from the underbody.

The stud may include a first portion and a second portion. The first portion may be between the underbody and the second portion. The spring may be between the second portion of the stud and the underbody and biasing the second portion away from the underbody.

The support frame may include a pair of arms spaced cross-vehicle from each other and a cross-member extending from one of the arms to the other of the arms at the second end of the support frame. The stud may be directly connected to the cross-member and the underbody.

The arms may be pivotally connected to the underbody at the first end and the arms are spaced downwardly from the underbody at the second end.

The support frame may be movable from a stowed position to a pivoted position. The second end may be movable away from the underbody as the support frame moves to the pivoted position.

The support frame may be movable from a stowed position to a pivoted position. The support frame may be in the stowed position when the stud is unreleased and the support frame may be in the pivoted position when the stud is released.

The support frame may be movable from a stowed position to a pivoted position and the tether may be designed to connect the support frame to the underbody in the pivoted position.

With reference to the Figures, wherein like numerals indicate like parts throughout the several views, a vehicle 10 includes an underbody 12 and a support frame 14 supported by the underbody 12. The support frame 14 is configured to support a spare wheel 16. The support frame 14 includes a first end 18 pivotally connected to the underbody 12 and a second end 20 releasably connected to the underbody 12. A tether 22 extends from the support frame 14 to the underbody 12. The tether 22 is fixed to the support frame 14 and the underbody 12. A stud 24 is between the support frame 14 and the underbody 12. The stud 24 is releasably connected to the underbody 12.

The support frame 14 is in the stowed position when the stud 24 is unreleased and the support frame 14 is in the pivoted position when the stud 24 is released. In the event of certain vehicle impacts, e.g., certain rear vehicle impacts, the support frame 14 may move from the stowed position to the pivoted position. Specifically, forces associated with certain vehicle impacts can move the support frame 14 from the stowed position to the pivoted position, as described further below. From the stowed position to the pivoted position, the second end 20 of the support frame 14 moves away from the underbody 12 and the spare wheel 16 pivots away from the underbody 12. Movement of the support frame to the pivoted position repositions the spare wheel 16 relative to a fuel tank 46 of the vehicle 10. Once the support frame 14 reaches the pivoted position, the tether 22 maintains the support frame 14 in the pivoted position such that the tether 22 bears the weight of the support frame 14 and the spare wheel 16 in the pivoted position.

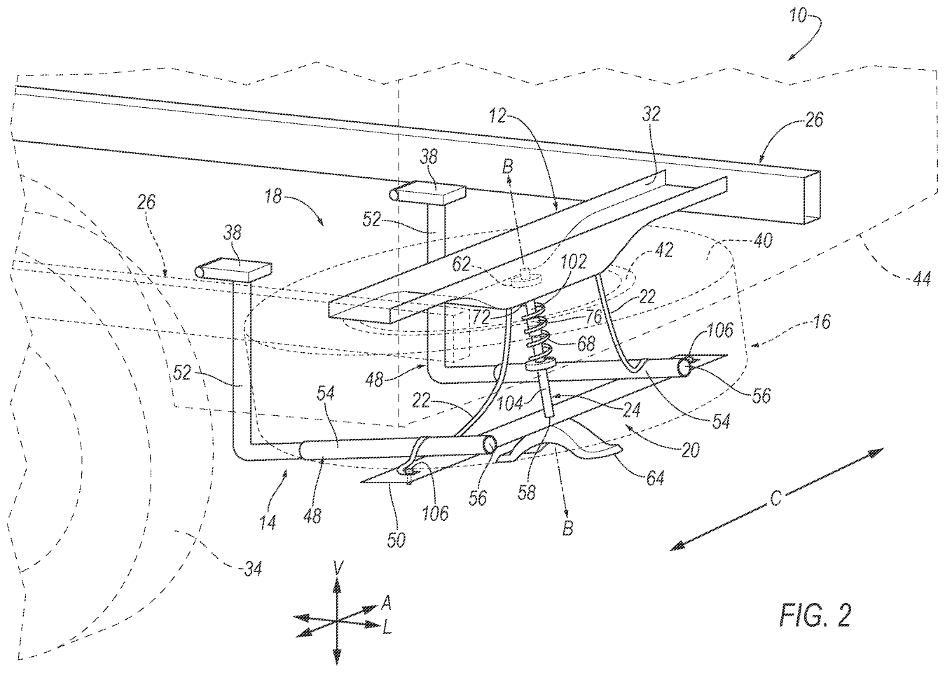

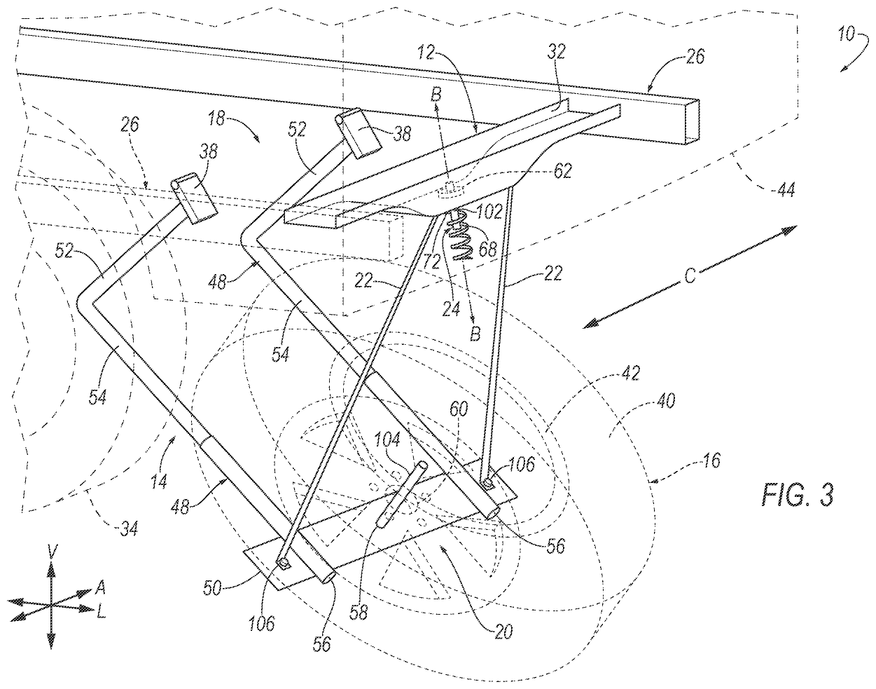

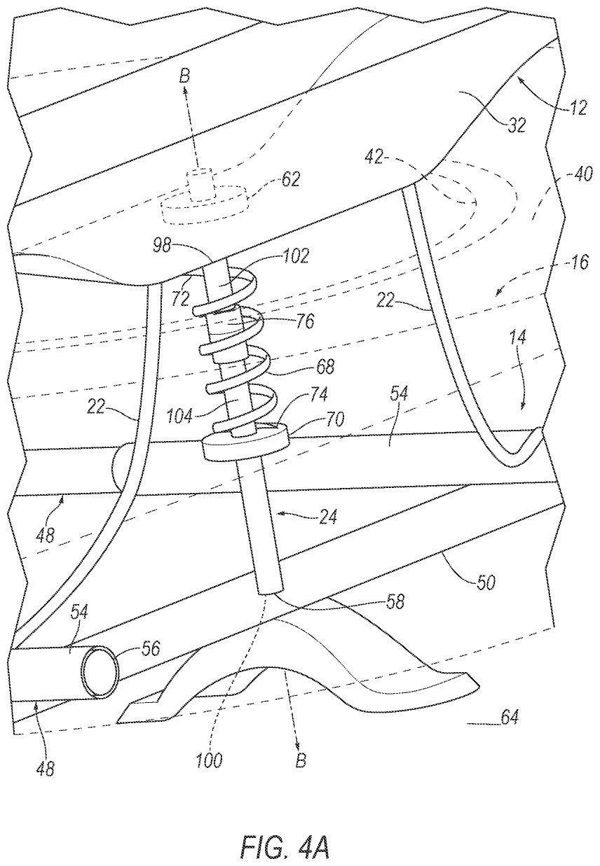

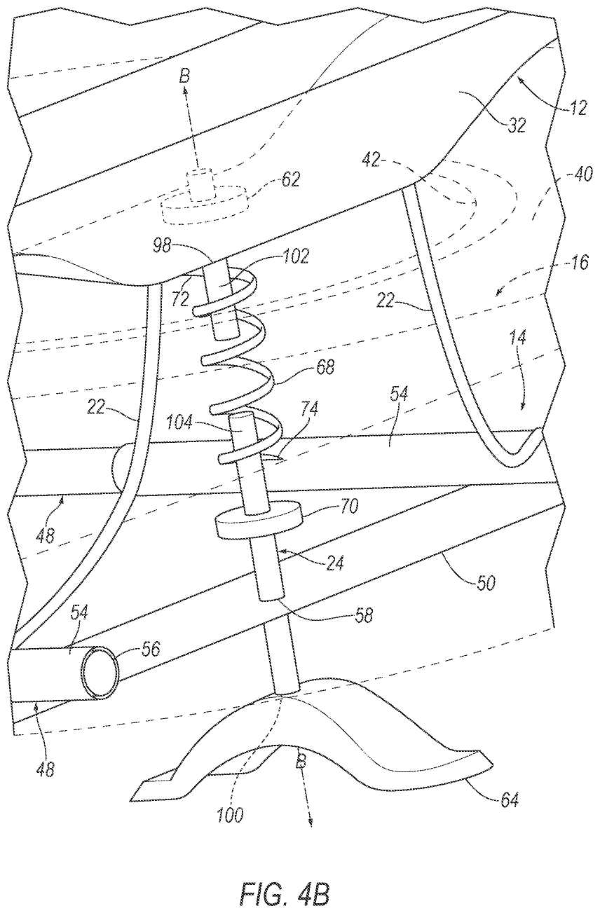

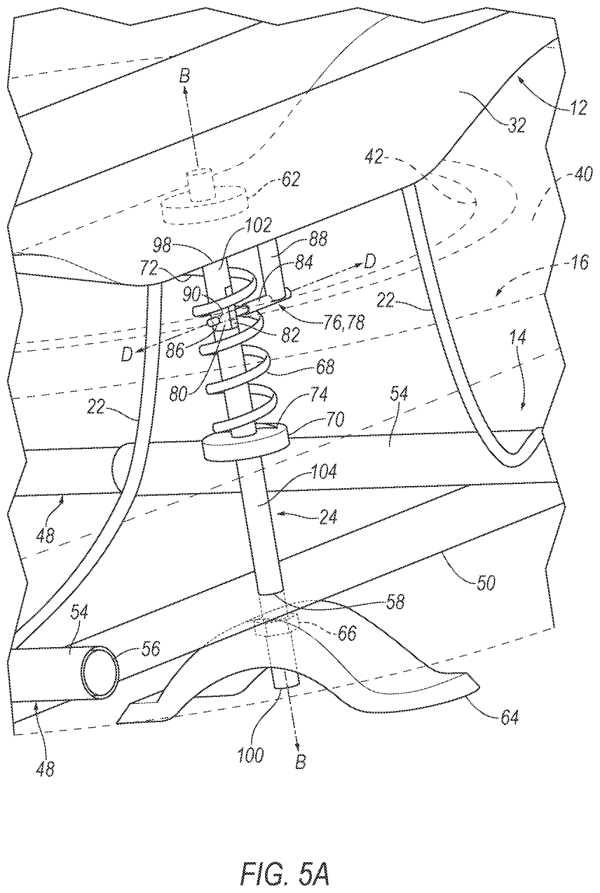

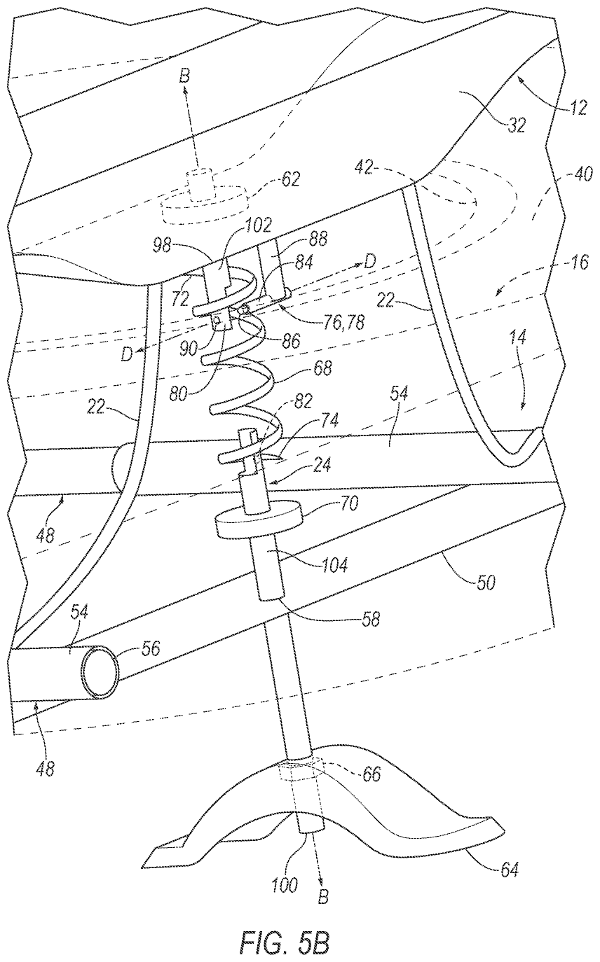

Two examples of the stud 24 and an actuator 76 are shown in the Figures and common numerals are used to identify common features in the examples. One example of the stud 24 and actuator 76 is shown in FIGS. 2-4B. In such an example, the actuator 76 is pyrotechnically activated. Another example of the stud 24 and the actuator 76 is shown in FIGS. 5A and 5B. In such an example the actuator 76 includes a solenoid 78.

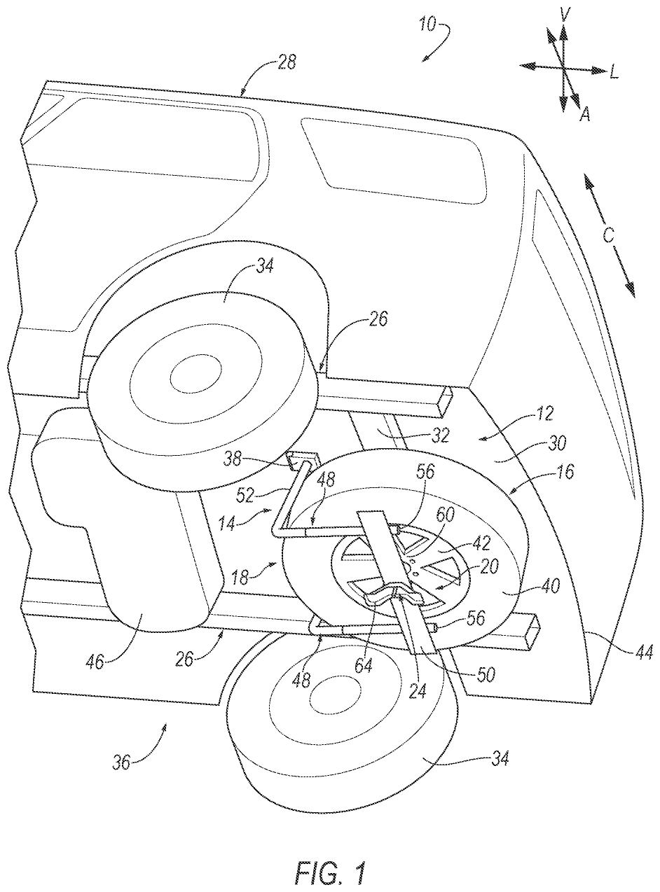

With reference to FIGS. 1, the vehicle 10 may be any suitable type of ground vehicle, e.g., a passenger or commercial automobile such as a sedan, a coupe, a truck, a sport utility, a crossover, a van, a minivan, a taxi, a bus, etc. Operations, systems, and methods described herein should always be implemented and/or performed in accordance with an applicable owner's/user's manual and/or safety guidelines.

The vehicle 10 defines a vehicle-longitudinal axis L extending between a front vehicle end (not numbered) and a rear vehicle end (not numbered) of the vehicle 10. The vehicle 10 defines a cross-vehicle axis A extending cross-vehicle from one side to the other side of the vehicle 10. A cross-vehicle direction C is parallel to the cross-vehicle axis A. The vehicle 10 defines a vertical axis V. The vehicle-longitudinal axis L, the cross-vehicle axis A, and the vertical axis V are perpendicular relative to each other.

The vehicle 10 includes a vehicle frame 26. The vehicle frame 26 may be of a unibody construction in which the frame is unitary with a vehicle body 28 (including frame rails, pillars, roof rails, etc.). As another example, the body and frame may have a body-on-frame construction (also referred to as a cab-on-frame construction) in which the body and frame are separate components, i.e., are modular, and the body is supported on and affixed to the frame. Alternatively, the frame and body may have any suitable construction. The frame and body may be of any suitable material, for example, steel, aluminum, and/or fiber-reinforced plastic, etc.

The vehicle 10 includes the underbody 12. The underbody 12 faces the road surface below the vehicle 10. The underbody 12 may, for example, include bottom surfaces of the vehicle 10 such as that of components of the vehicle frame 26, vehicle body 28, etc., including, for example, rails, panels, pans, etc. In the example shown in the Figures, the underbody 12 includes a floor pan 30 and at least one cross-rail 32 extending in the cross-vehicle direction C.

The vehicle 10 includes a plurality of the operating wheels 34, typically four operating wheels 34. The operating wheels 34 include inflatable rings mounted to operating wheels of the vehicle 10. The operating wheels 34 provide shock absorption and traction as the vehicle 10 moves along a roadway. Each operating wheel 34 and respective operating wheel defines a toroidally shaped inflation chamber that may be filled with pressurized inflation medium, such as air. The operating wheels may be formed of synthetic or natural rubber, or other elastomeric materials that provide sufficient elasticity, durability, and grip. The operating wheels may also include cords (not shown) running through the elastomeric material and/or chemical compounds added to the elastomeric material.

The spare wheel 16 may be supportable by the vehicle 10. The spare wheel 16 is a replacement for one of the operating wheels, e.g., when one of the tires is flat or otherwise inoperable. The spare wheel 16 may be designed for limited use, e.g., having a lower speed rating, a smaller diameter, etc., than the operating wheels. The spare wheel 16 includes a tire portion 40 and a hub portion 42. The tire portion 40 and the hub portion 42 have the same structure as just described for the operating wheel 34 and operating wheel. The spare wheel 16 may be identical to the operating wheel 34 and operating wheel or may be sized differently, e.g., a compact spare.

The spare wheel 16 is located on an underside 36 of the vehicle 10. Specifically, the spare wheel 16 is removably supported by the underbody 12 of the vehicle 10 by the support frame 14, as described further below. The spare wheel 16 may be removed from the underside 36 of the vehicle 10 in the event that an operating wheel 34 has become inoperable, i.e., the spare wheel 16 is removed from the underbody 12 to replace an operating wheel 34. As shown in the Figures, the spare wheel 16 may be located directly between a bumper 44 of the vehicle 10 and one of a fuel tank 46 or an electric-vehicle battery (not shown) of the vehicle 10.

The vehicle 10 includes the support frame 14 supported by the underbody 12. The support frame 14 is configured to support the spare wheel 16 of the vehicle 10. Specifically, the support frame 14 is configured to support the spare wheel 16 of the vehicle 10 between the roadway under the vehicle 10 and the underbody 12 of the vehicle 10. In other words, the spare wheel 16 may be stowed below the underbody 12 by the support frame 14. The support frame 14 is sized and shaped to support the spare wheel 16 in such a way that the spare wheel 16 travels with the vehicle 10 during operation of the vehicle 10 and such that the spare wheel 16 may be accessed from under the vehicle 10 to remove the spare wheel 16 and replace an operating wheel 34 in the event that the operating wheel 34 becomes inoperable. The support frame 14 may cradle the spare wheel 16 under the underbody 12 such that the spare wheel 16 remains supported by the underbody 12 as the vehicle 10 moves along the roadway.

The support frame 14 is pivotally supported by the underbody 12. Specifically, the support frame 14 is pivotally connected to the underbody 12. The underbody 12 may include hinges 38 coupled to the support frame 14 such that the support frame 14 is pivotable relative to the underbody 12. The support frame 14 is movable between the stowed position and the pivoted position. The support frame 14 is in the stowed position during operation of the vehicle 10. Specifically, the support frame 14 supports the spare wheel 16 in the stowed position between the underbody 12 of the vehicle 10 and the roadway. In other words, the spare wheel 16 is stowed between the underbody 12 of the vehicle 10 and the roadway during operation of the vehicle 10. The support frame 14 may be manually moved to the pivoted position to add the spare wheel 16 or remove the spare wheel 16. In other situations, e.g., upon detection of certain vehicle impacts, the support frame 14 may move to the pivoted position automatically upon detection of the certain vehicle impacts, e.g., certain rear vehicle impacts. The support frame 14 is fixed to the underbody 12 relative to the vehicle-longitudinal axis L and the cross-vehicle axis A. In other words, the support frame 14 is not movable relative to the underbody 12 along either of the vehicle-longitudinal axis L or the cross-vehicle axis A.

The support frame 14 includes the first end 18 to the second end 20. Specifically, the support frame 14 extends along the vehicle-longitudinal axis L from the first end 18 to the second end 20. The arms 48 are adjacent to, e.g., connected to, the underbody 12 at the first end 18 and the support frame 14 is spaced downwardly from the underbody 12 at the second end 20. In other words, the first end 18 is directly connected to the underbody 12 (i.e., with no other components are between the first end 18 and the underbody 12) and the second end 20 is indirectly connected to the underbody 12 by the first end 18 (i.e., with the first end 18, between the second end 20 and the underbody 12. The first end 18 and the second end 20 are spaced from each other along the vehicle-longitudinal axis L. Specifically, the first end 18 is spaced vehicle-forward of the second end 20. The first end 18 of the support frame 14 may be between the second end 20 and the fuel tank 46 of the vehicle 10 along the vehicle-longitudinal axis L. In other words, the first end 18 is vehicle-inboard from of the second end 20 of the support frame 14 along the vehicle-longitudinal axis L.

The first end 18 is pivotally connected to the underbody 12. Specifically, the first end 18 may be coupled to the hinges 38 of the underbody 12 such that the first end 18 is pivotable relative to the underbody 12. The first end 18 pivots about the hinges 38 to move the support frame 14 to the pivoted position. The second end 20 is releasably connected to the underbody 12. Specifically, the second end 20 is releasably connected to allow the support frame 14 to pivot from the stowed position to the pivoted position. In other words, the second end 20 is unreleased when the support frame 14 is in the stowed position and the second end 20 is released when the support frame 14 is in the pivoted position. As the support frame 14 moves from the stowed position to the pivoted position, the second end 20 moves away from the underbody 12. The second end 20 may be manually released to move the support frame 14 to the pivoted position to add the spare wheel 16 or remove the spare wheel 16. The second end 20, as discussed further below, may be automatically released in the event of certain vehicle impacts to move the support frame 14 to the pivoted position.

The support frame 14 includes a pair of arms 48 and a cross-member 50 between the arms 48. The arms 48 are spaced from each other in the cross-vehicle direction C. The arms 48 are connected to the underbody 12 at the first end 18. Specifically, the arms 48 are pivotally connected to the underbody 12 at the first end 18 of the support frame 14. The arms 48 pivot relative to the underbody 12 from the stowed position to the pivoted position. In other words, the arms 48 may be coupled to the hinges 38 at the first end 18 to allow the arms 48 to pivot from the stowed position to the pivoted position.

The arms 48 each include an upper portion 52 and a bottom portion 54. The arms 48 are pivotally connected to the underbody 12 at the upper portions 52. The upper portions 52 may be coupled to the hinges 38 to allow the support frame 14 to move from the stowed position to the pivoted position. The upper portions 52 may each extend downwardly from the underbody 12 toward the roadway. The upper portions 52 of the arms 48 extend downwardly from the hinges 38 of the underbody 12 to the bottom portions 54 of the arms 48. Specifically, the upper portions 52 each extend downwardly at least partially along the vertical axis V of the vehicle 10 when the support frame 14 is in the stowed position. In other words, the upper portions 52 may be generally vertical when the support frame 14 is in the stowed position. The adjective “generally” means that the upper portions 52 may deviate from vertical in the stowed position due to design or tolerances of the arms 48. The upper portions 52 of the arms 48 are elongated along an upright direction when the support frame 14 is in the stowed position. As the support frame 14 moves to the pivoted position, the upper portions 52 pivot relative to the underbody 12. In other words, in the pivoted position, the upper portions 52 of the support frame 14 are angled relative to the underbody 12. Specifically, in the pivoted position, the upper portions 52 may be elongated transverse to the vertical axis V in the pivoted position.

The upper portions 52 are vehicle-forward of the spare wheel 16 when the spare wheel 16 is supported by the support frame 14. The upper portions 52 may be between the spare wheel 16 and the fuel tank 46 along the vehicle-longitudinal axis L. In other words, the fuel tank 46 is vehicle-forward of the upper portions 52 of the arms 48.

The bottom portions 54 of the arms 48 may be elongated along the vehicle-longitudinal axis L. The bottom portions 54 of the arms 48 are elongated from the upper portions 52 to distal ends 56 spaced from the upper portions 52 along the vehicle-longitudinal axis L. Specifically, the distal ends 56 are at the second end 20 of the support frame 14. In the stowed position, the bottom portions 54 are spaced downwardly from the underbody 12 by the upper portions 52 of the arms 48. As the support frame 14 moves to the stowed position, the bottom portions 54 move away from the underbody 12. Specifically, the second end 20, i.e., the distal ends 56 of the bottom portions 54, move downwardly away from the underbody 12 toward the roadway under the vehicle 10.

The spare wheel 16 may rest on the bottom portions 54 of the arms 48 when the support frame 14 is in the stowed position. The spare wheel 16 is between the bottom portions 54 of the arms and the underbody 12 along the vertical axis V of the vehicle 10 when the support frame 14 is in the stowed position.

The cross-member 50 is connected to the support frame 14 at the second end 20 of the support frame 14. Specifically, the cross-member 50 extends from one arm 48 to the other of the arms 48 at the second end 20 of the support frame 14. The cross-member 50 may be between the bottom portions 54 of the arms 48 and the underbody 12 of the vehicle 10. The cross-member 50 may be between the bottom portions 54 and the underbody 12 of the vehicle 10. The spare wheel 16 is between the cross-member 50 and the underbody 12 of the vehicle 10. The spare wheel 16 may rest on the cross-member 50 between the cross-member 50 and the underbody 12 of the vehicle 10 when the vehicle 10 is in operation.

The stud 24 is between the support frame 14 and the underbody 12. Specifically, the stud 24 is between the cross-member 50 of the support frame 14 and the underbody 12. The stud 24 extends from the support frame 14 to the underbody 12. Specifically, the stud 24 extends from the cross-member 50 of the support frame 14 to the underbody 12. The stud 24 is configured to maintain the support frame 14 in stowed position. The stud 24 extends through the cross-member 50, e.g., through a hole 58 defined by the cross-member 50, and the spare wheel 16 to engage with the underbody 12 to maintain the support frame 14 in the stowed position. For example, the spare wheel 16 may include a center 60 of the spare wheel 16 and the stud 24 may extend through the hole 58 in the cross-member 50 and the center 60 of the spare wheel 16 to the underbody 12.

The stud 24 includes a first portion 102 and a second portion 104. The stud 24 is elongated along a first axis B that may be along the vertical axis V. Specifically, the stud 24 may include a top end 98 and a bottom end 100 and the stud 24 may be elongated from the top end 98 to the bottom end 100 along the first axis B. In the examples shown in the Figures, the first portion 102 includes the top end 98 and the second portion 104 includes the bottom end 100. The first portion 102 and the second portion 104 are elongated along the first axis B. The first portion 102 is between the underbody 12 and the second portion 104. Specifically, the first portion 102 is between the underbody 12 and the second portion 104 along the first axis B. The second portion 104 is between the support frame 14 and the first portion 102. Specifically, the second portion 104 is between the cross-member 50 of the support frame 14 and the first portion 102 of the stud 24.

Two examples of the stud 24 are shown in the Figures. In the two examples shown in the Figures, the stud 24 is directly connected to the cross-member 50 and the underbody 12 of the vehicle 10. The first portion 102 is directly connected to the underbody 12 and the second portion 104 is directly connected to the cross-member 50 of the support frame 14. When the stud 24 is connected to the cross-member 50 and the underbody 12, the support frame 14 is in the stowed position. In the first example shown in FIGS. 2-4B, the stud 24 may be threaded to connect the first portion 102 of the stud 24 to the underbody 12 of the vehicle 10. The top end 98 of the first portion 102 may be threaded. The underbody 12 may include a threaded weld nut 62 that the top end 98 may be threaded into. A handle 64 may be fixed to the bottom end 100 of the second portion 104. To manually add the spare wheel 16 to the vehicle 10 or to manually remove the spare wheel 16 from the vehicle 10, the stud 24 may be guided through the hole 58 in the cross-member 50 and the center 60 of the spare wheel 16 and turned by an operator turning the handle 64 to connect the stud 24 to the underbody 12 and the spare wheel 16 to the underbody 12. In the second example shown in FIGS. 5A and 5B, the stud 24 may be fixed to the underbody 12. In such an example, the stud 24 may be welded or otherwise fixed to the underbody 12. The bottom end 100 of the second portion 104 may be threaded. A handle 64 may be fitted over the bottom end 100 and a nut 66 may be tightened around the second portion 104. To manually add spare wheel 16 to the vehicle 10 or to manually remove the spare wheel 16 from the vehicle 10, the center 60 of the spare wheel 16 may be fitted over the stud 24 and an operator may tighten the nut 66 and handle 64 to maintain the support frame 14 and spare wheel 16 to the underbody 12.

In the event of certain vehicle impacts, e.g., certain rear vehicle impacts, the stud 24 may release from the underbody 12 to allow the support frame 14 to move to the pivoted position. The support frame 14 is in the stowed position when the stud 24 is unreleased and the support frame 14 is in the pivoted position when the stud 24 is released. In the pivoted position, the second end 20 of the support frame 14 moves away from the underbody 12 and the spare wheel 16 pivots away from the underbody 12. The pivoted position of the support frame 14 and the spare wheel 16 allows for the support frame 14 and tire to manage energy from the certain vehicle impact.

The stud 24 is releasably connected to the underbody 12. Specifically, the first portion 102 is releasably connected to the second portion 104 to release the stud 24 from the underbody 12. In other words, the first portion 102 releases from the second portion 104 to allow the support frame 14 to move to the pivoted position. When the first portion 102 and the second portion 104 are unreleased, the support frame 14 is in the stowed position. When the first portion 102 is released from the second portion 104, the support frame 14 is in the pivoted position.

The vehicle 10 includes a spring 68 between the stud 24 and the underbody 12. Specifically, the spring 68 is between the second portion 104 of the stud 24 and the underbody 12. In the examples shown in the Figures, an upper end 72 of the spring 68 is fixed to the underbody 12 of the vehicle 10 and the stud 24 includes a ring 70 fixed to the stud 24 that contacts a lower end 74 of the spring 68. The ring 70 is fixed to the second portion 104 of the stud 24. In other words, the ring 70 may be fixed at a position along the first axis B spaced downwardly from the underbody 12 and the first portion 102 of the stud 24. Specifically, the spring 68 is between the ring 70 and the underbody 12.

The spring 68 biases the stud 24 away from the underbody 12. Specifically, the spring 68 biases the second portion 104 of the stud 24 away from the underbody 12 along the first axis B. In other words, during operation of the vehicle 10, the spring 68 may be compressed along the first axis B. When the stud 24 is released and the support frame 14 moves toward the pivoted position, the spring 68 expands along the first axis B and applies a force to the stud 24 to bias the support frame 14 away from the underbody 12 in addition to gravity acting on the support frame 14. In other words, as the spring 68 extends, the spring 68 biases the second portion 104 of the stud 24 away from the underbody 12 such that the support frame 14 moves toward the pivoted position.

The vehicle 10 includes the tether 22 extending from the support frame 14 to the underbody 12. In the example shown in the Figures, the vehicle 10 includes two tethers 22 extending from the support frame 14 to the underbody 12. Specifically, the tethers 22 extend from the underbody, e.g., the cross-rail 32, to the cross-member 50 of the support frame 14. The spare wheel 16 is between the two tethers 22 along the cross-vehicle direction C. The tethers 22 are designed to connect the support frame 14 to the underbody 12 in the pivoted position. Specifically, the tethers 22 are designed to connect the second end 20 of the support frame 14 to the underbody 12 when the support frame 14 is in the pivoted position. When the support frame 14 is in the pivoted position, the tethers 22 may bear weight of the spare wheel 16 and the second end 20 of the support frame 14. In other words, the tethers 22 prevent the support frame 14 from moving past the pivoted position. The tethers 22 are fixed to the support frame 14 and the underbody 12. Specifically, the tethers 22 may be fixed in any suitable way such that the spare wheel 16 may be manually added or removed from the vehicle 10. In the examples shown in the Figures, the tethers 22 are fixed by bolts 106 that extend through the tethers 22 and the cross-member 50.

The tethers 22 may be of any suitable material to bear the weight of the support frame 14 and the spare wheel 16 and be flexible about the spare wheel 16 when the spare wheel 16 was installed on the support frame 14. For example, the tether 22 may be woven fabric. In such an example, the woven fabric may be of any suitable type including nylon, polyester, carbon fiber, composite, etc. In other examples, the tether 22 may be braided, e.g., braided wires or fibers, or a chain. In such examples, the tether 22 may be metal.

In the examples shown in the Figures, the vehicle 10 includes an actuator 76 operatively connecting the stud 24 to the underbody 12 to release the stud 24 from the underbody 12. The actuator 76 is between the first portion 102 and the second portion 104 along the first axis B of the stud 24 and releases the stud 24 to allow the support frame 14 to move to the pivoted position. In other words, the actuator 76 allows the stud 24 to release and the support frame 14 to move to the pivoted position. Specifically, the actuator 76 releases the first portion 102 from the second portion 104 to move the support frame 14 to the pivoted position. As described further below, two examples of actuators 76 are shown in the Figures. When the actuator 76 is activated, the second portion 104 of the stud 24 may remain fixed relative to the underbody 12 of the vehicle 10 and the first portion 102 moves downwardly away from the underbody 12 as the support frame 14 moves to the pivoted position. As the support frame 14 moves to the pivoted position and after the actuator 76 has been activated, the spring 68 extends and applies a force to the second portion 104 to move the second portion 104 away from the underbody 12. In the pivoted position, the first portion 102 and the second portion 104 are separated from each other and the tether 22 bears the weight of the spare wheel 16 and the support frame 14.

In the example shown in FIGS. 2-4A, the actuator 76 is pyrotechnically activated. In such an example, the actuator 76 includes a pyrotechnic charge that activates the actuator 76 to release the first portion 102 from the second portion 104. The pyrotechnic charge may be between the first portion 102 of the stud 24 and the second portion 104 of the stud 24 along the first axis B. When the actuator 76 is activated, the pyrotechnic charge may physically separate the first portion 102 from the second portion 104 to release the support frame 14 from the underbody 12. The pyrotechnic charge may be combustible to produce a gas. The pyrotechnic charge may be formed of a solid mixture of substances that, when ignited, react to produce the gas. For example, the pyrotechnic charge may be formed of sodium azide (NaNO3), potassium nitrate (KNO3), and silicon dioxide (SiO2), which react to form nitrogen gas (N2).

In the example shown in FIGS. 5A and 5B, the actuator 76 includes a solenoid 78 between the first portion 102 and the second portion 104. between the first portion 102 and the second portion 104 of the stud 24. The solenoid 78 is engageable with the stud 24 to maintain connection between the first portion 102 and the second portion 104. Specifically, the solenoid 78 may be engageable with the first portion 102 and the second portion 104 of the stud 24. In the example shown in FIGS. 5A and 5B, the first portion 102 includes a flange 80 and the second portion 104 includes a flange 82. When the solenoid 78 is engaged with the first portion 102 and the second portion 104, the flanges 80, 82 overlap each other along the first axis B. The solenoid 78 includes a housing 84 fixed relative to the underbody 12 and a plunger 86 that is movable relative to the housing 84. The solenoid 78 is supported by the underbody 12. Specifically, the solenoid 78 is fixed relative to the underbody 12. A bracket 88 fixed to the underbody 12 may extend downwardly from the underbody 12 to the housing 84 of the solenoid 78 to fix the solenoid 78 relative to the underbody 12.

The solenoid 78 is elongated along a second axis D that is transverse to the first axis B. For example, the second axis D may be perpendicular to the first axis B. In other words, the solenoid 78 may be elongated in a direction that is transverse to the stud 24, e.g., the first portion 102 and the second portion 104. The housing 84 of the solenoid 78 and the plunger 86 of the solenoid 78 are elongated along the second axis D. The plunger 86 moves relative to the housing 84 along the second axis D.

The plunger 86 of the solenoid 78 is engageable with the stud 24. Specifically, the plunger 86 of the solenoid 78 is releasably engageable the first portion 102 and the second portion 104. The plunger 86 is releasably engaged with the flange 80 of the first portion 102 and the flange 82 of the second portion 104 when the support frame 14 is in the stowed position. Each of the flanges 80, 82 may define a hole 90 aligned with the plunger 86 of the solenoid 78 and the plunger 86 is receivable by the holes 90 of the flanges 80, 82 to engage the first portion 102 and the second portion 104. During operation of the vehicle 10, the solenoid 78 remains engaged with the holes 90. In the event of certain vehicle impacts, the solenoid 78 is activated and the plunger 86 is retracted from the holes 90. In such an instance, the plunger 86 disengages from the stud 24 and the second portion 104 is released from the first portion 102 such that the support frame 14 may move the pivoted position.

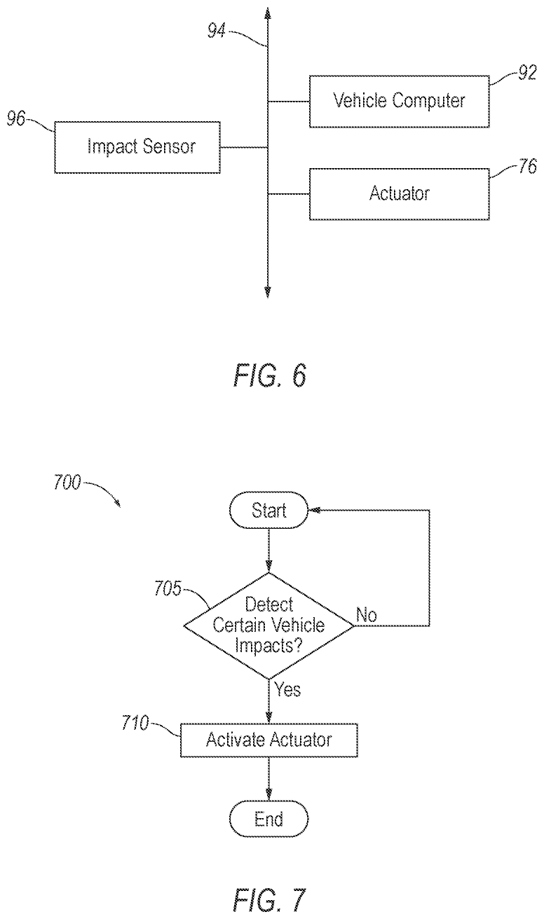

With continued reference to FIG. 6, the vehicle 10 includes a vehicle computer 92 including a processor and a memory storing instructions executable by the processor. The memory includes one or more forms of computer readable media, and stores instructions executable by the vehicle computer 92 for performing various operations, including as disclosed herein. The vehicle computer 92 may be a restraints control module or a body control module. The vehicle computer 92 can be a generic computer with the processor and the memory as described above and/or may include an electronic control unit ECU or controller for a specific function or set of functions, and/or a dedicated electronic circuit including an ASIC (application specific integrated circuit) that is manufactured for a particular operation, e.g., an ASIC for processing sensor data and/or communicating the sensor data. In another example, the vehicle computer 92 may include an FPGA (Field-Programmable Gate Array) which is an integrated circuit manufactured to be configurable by a user. Typically, a hardware description language such as VHDL (Very High-Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g. stored in a memory electrically connected to the FPGA circuit. In some examples, a combination of processor(s), ASIC(s), and/or FPGA circuits may be included in the vehicle computer 92.

The vehicle computer 92 is generally arranged for communications on a vehicle communication network 94 that can include a bus in the vehicle 10 such as a controller area network CAN or the like, and/or other wired and/or wireless mechanisms. Alternatively or additionally, in cases where the vehicle computer 92 actually comprises a plurality of devices, the vehicle communication network 94 may be used for communications between devices represented as the vehicle computer 92 in this disclosure. Further, as mentioned below, various controllers and/or sensors may provide data to the vehicle computer 92 via the vehicle communication network 94.

The vehicle 10 may include at least one impact sensor 96 for sensing certain vehicle impacts (e.g., impacts of a certain magnitude, direction, etc.), and the vehicle computer 92 in communication with the impact sensor 96 and the inflator. The vehicle computer 92 may activate the inflator, e.g., provide an impulse to a pyrotechnic charge of the inflator when the impact sensor 96 senses certain vehicle impacts. The impact sensor 96 may be configured to sense certain vehicle impacts prior to impact, i.e., pre-impact sensing. The impact sensor 96 may be in communication with the vehicle computer 92. The impact sensor 96 is configured to detect certain vehicle impacts. In other words, a “certain vehicle impact” is an impact of the type and/or magnitude for which the actuator 76 is activated to move the support frame 14 to the pivoted position, i.e., “certain” indicates the type and/or magnitude of the impact. The type and/or magnitude of such “certain vehicle impacts” may be pre-stored in the vehicle computer 92, e.g., a restraints control module and/or a body control module. The impact sensor 96 may be of any suitable type, for example, post contact sensors such as accelerometers, pressure sensors, and contact switches; and pre-impact sensors such as radar, LIDAR, and vision sensing systems. The vision sensing systems may include one or more cameras, CCD image sensors, CMOS image sensors, etc. The impact sensor 96 may be located at numerous points in or on the vehicle 10.

With reference to FIG. 7, the vehicle computer 92 stores instructions to control components of the vehicle 10 according to the method 700. Specifically, the method 700 includes releasing the stud 24 in the event of certain vehicle impacts. Use of “in response to,” “based on,” and “upon determining” herein, including with reference to method 700, indicates a causal relationship, not merely a temporal relationship.

With reference to decision block 705, the method 700 includes detecting certain vehicle impacts. Specifically, the method 700 includes detecting certain rear vehicle impacts. The impact sensors 96 may send a signal to the vehicle computer 92 indicating whether certain rear vehicle impacts are detected. If certain rear vehicle impacts are detected, the method 700 moves to decision block 710. If no certain rear vehicle impact is detected, the method 700 returns to its start.

With reference to block 710, based on detection of certain vehicle impacts, the method 700 includes activating the actuator 76 to release the stud 24 from the underbody 12. The vehicle computer 92 may send a signal to the actuator 76 to release the first portion 102 of the stud 24 from the second portion 104 of the stud 24 such that the support frame 14 moves to the pivoted position. After the actuator 76 is activated, the method 700 ends.

The disclosure has been described in an illustrative manner, and it is to be understood that the terminology which has been used is intended to be in the nature of words of description rather than of limitation. The numerical adverbs “first” and “second” are used herein merely as identifiers and do not signify order or importance. Many modifications and variations of the present disclosure are possible in light of the above teachings, and the disclosure may be practiced otherwise than as specifically described.

What is claimed is:

1. A vehicle comprising:
an underbody;
a support frame supported by the underbody, the support frame being configured to support a spare wheel;
the support frame including a first end pivotally connected to the underbody and a second end releasably connected to the underbody;
a tether extending from the support frame to the underbody, the tether being fixed to the support frame and the underbody; and
a stud between the support frame and the underbody;
the stud being releasably connected to the underbody.

2. The vehicle of claim 1, further comprising an actuator operatively connecting the stud to the underbody to release the stud from the underbody.

3. The vehicle of claim 2, wherein the stud includes a first portion and a second portion, the first portion being between the underbody and the second portion, and the actuator being between the first portion and the second portion.

4. The vehicle of claim 3, wherein the actuator includes a solenoid between the first portion of the stud and the second portion of the stud, the solenoid including a housing and a plunger.

5. The vehicle of claim 4, wherein the stud is elongated along a first axis and the plunger of the solenoid is elongated along a second axis transverse to the first axis, the plunger being releasably engaged with the first portion and the second portion along the second axis.

6. The vehicle of claim 3, wherein the stud is elongated along a first axis, the actuator being between the first portion of the stud and the second portion of the stud along the first axis and the actuator being pyrotechnically activated.

7. The vehicle of claim 2, wherein the actuator is pyrotechnically activated.

8. The vehicle of claim 1, further comprising a computer including a processor and a memory storing instructions executable by the processor to:
detect certain vehicle impacts; and
based on detection of certain vehicle impacts, activate an actuator to release the stud from the underbody.

9. The vehicle of claim 1, wherein the stud extends from the support frame to the underbody.

10. The vehicle of claim 1, further comprising a spring between the stud and the underbody, the spring biasing the stud away from the underbody.

11. The vehicle of claim 10, wherein the stud includes a first portion and a second portion, the first portion being between the underbody and the second portion, the spring being between the second portion of the stud and the underbody and biasing the second portion away from the underbody.

12. The vehicle of claim 1, wherein the support frame includes a pair of arms spaced cross-vehicle from each other and a cross-member extending from one of the arms to the other of the arms at the second end of the support frame, the stud being directly connected to the cross-member and the underbody.

13. The vehicle of claim 12, wherein the arms are pivotally connected to the underbody at the first end and the arms are spaced downwardly from the underbody at the second end.

14. The vehicle of claim 1, wherein the support frame is movable from a stowed position to a pivoted position, the second end being movable away from the underbody as the support frame moves to the pivoted position.

15. The vehicle of claim 1, wherein the support frame is movable from a stowed position to a pivoted position, the support frame being in the stowed position when the stud is unreleased and the support frame being in the pivoted position when the stud is released.

16. The vehicle of claim 1, wherein the support frame is movable from a stowed position to a pivoted position and the tether is designed to connect the support frame to the underbody in the pivoted position.
